(19) United States
(12) Patent Application Publication
(10) Pub. No.: US 2025/0298432 A1
(43) Pub. Date: Sep. 25, 2025

(54) TRANSMITTER-SIDE LINK TRAINING WITH IN-BAND HANDSHAKING

(71) Applicant: NVIDIA Corp., Santa Clara, CA (US)

(72) Inventors: Seema Kumar, Santa Clara, CA (US); Ish Chadha, San Jose, CA (US)

(73) Assignee: NVIDIA Corp., Santa Clara, CA (US)

(21) Appl. No.: 18/615,238

(22) Filed: Mar. 25, 2024

(51) Int. Cl. G06F 1/10; H04L 7/00

(52) U.S. Cl. CPC G06F 1/10; H04L 7/0008

(57) ABSTRACT

Systems including a first circuit and a second circuit, with a multi-data lane link between the first circuit and the second circuit. The first circuit and the second circuit are configured to determine a delay setting of a clock signal forwarded from the first circuit to the second circuit by utilizing a first distinct subset of the data lanes to communicate commands redundantly encoded in multiple unit intervals of the data lanes and by utilizing a second distinct subset of the data lanes to communicate results of the commands.

### BACKGROUND

A chip-to-chip link may comprise a number N of serial data lanes and at least one clock lane that forwards the transmitter chip clock signal to the receiver chip. An additional M control lanes (EN) may also be utilized, for example to implement multiple power or bandwidth modes on the link. A link may be used for communication between two chips/dies on a circuit board or in a multi-chip module. (Herein, the terms chip and die are used interchangeably). In a multi-chip module multiple integrated circuit dies are assembled into a single package, providing a higher level of integration than can be achieved with a single chip. The interconnected dies in an multi-chip module are often functionally heterogeneous.

In some implementations, the links may communicate functional data, cache coherency messages, memory operations, or configuration and status register transactions.

Configuring the link for high-speed communications may pose challenges due to the inherent latencies that characterize the link and the logic on both ends (at the transmitter and the receiver). A dedicated low-speed side band channel may be utilized for exchanging messages between the transmitter and receiver to determine a delay value to apply to a clock signal forwarded from the transmitter to the receiver. This mechanism has the disadvantage of increasing the pin count (and hence circuit area) for the link. It also reduces link efficiency as the extra pin(s) may not carry high-speed signals during normal (after setup) operation. Another mechanism to determine the delay setting on the forwarded clock involves switching the link between low and high bandwidth operation, but this adds complexity to the design and can potentially degrade high speed performance. Another approach utilizes special software or other logic to manage the initial link configuration, but this approach may be impractical when the link is the only path between the components. Moreover, mechanisms of this type may be undesirably slow.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an exemplary configuration of a transmitter and a receiver.

FIG. 2 depicts an exemplary configuration of data lane between a transmitter and a receiver.

FIG. 3 depicts an in-band messaging process in one embodiment.

FIG. 4A depicts a link configuration process in accordance with one embodiment.

FIG. 4B depicts a link configuration process in accordance with another embodiment.

FIG. 5 depicts a parallel processing unit 520 in accordance with one embodiment.

FIG. 6 depicts a general processing cluster 600 in accordance with one embodiment.

FIG. 7 depicts a memory partition unit 700 in accordance with one embodiment.

FIG. 8 depicts a streaming multiprocessor 800 in accordance with one embodiment.

FIG. 9 depicts a processing system 900 in accordance with one embodiment.

FIG. 10 depicts an exemplary processing system 1000 in accordance with another embodiment.

FIG. 11 depicts a graphics processing pipeline 1100 in accordance with one embodiment.

### DETAILED DESCRIPTION

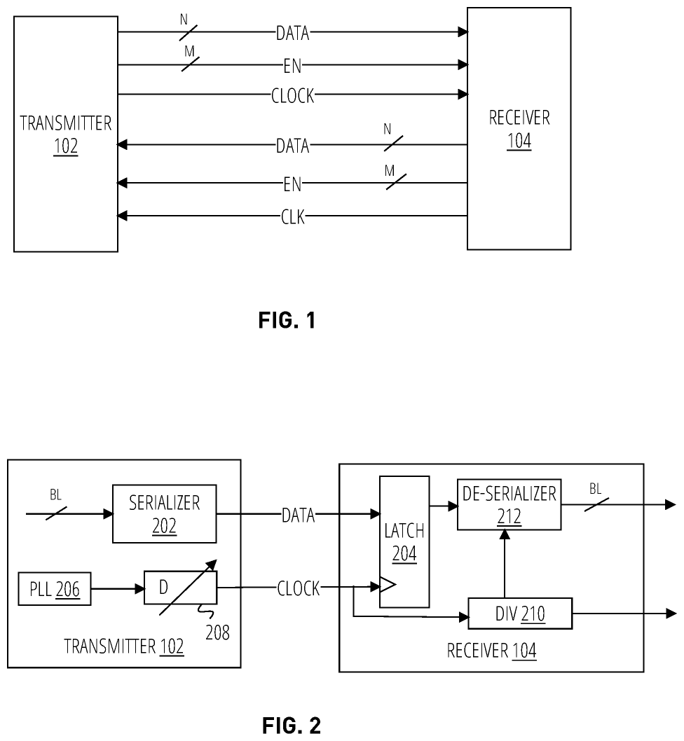

FIG. 1 depicts an exemplary configuration of a transmitter 102 and a receiver 104. A chip-to-chip link couples two chips. Although in this depiction one chip is identified as the transmitter and the other as a receiver, in practice each chip may operate as a transmitter or a receiver of data. Data from the transmitter 102 is associated with a forwarded clock. The receiver 104 applies the forwarded clock to latch the transmitted data. Some implementations may also utilize additional control lines (EN) dedicated to the exchange of control/configuration messages.

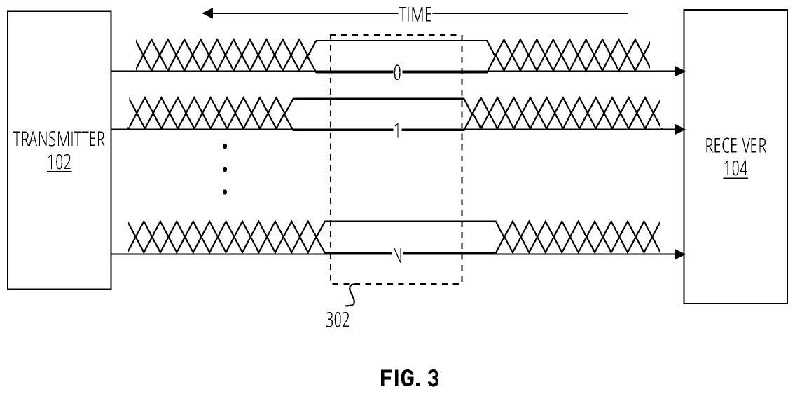

FIG. 2 depicts an exemplary configuration of data lane between a transmitter 102 and a receiver 104. A burst of parallel bits (BL) is transformed by a serializer 202 in the transmitter into a serial bit stream that is communicated over the data lane to the receiver 104, wherein the data bits are sequentially latched (via latch 204). A phase-locked loop 206 (or other mechanism) in the transmitter 102 generates a periodic clock signal that is passed through a configurable delay circuit 208 and forwarded to the receiver to clock the latch 204. The forwarded clock signal is divided (via a clock divider 210) and applied to drive a de-serializer 212 in the receiver 104, reproducing the parallel data burst.

Data for a lane is received as a parallel burst. The parallel burst is serialized (by serializer 202) onto the data lane at a bandwidth set by a clock generated, for example, by a phase-locked loop 206. A delayed version of the clock signal is communicated over the forwarded clock lane. The delay for a particular data lane is adjustable via a configurable delay circuit 208. On the receiver side, the forwarded clock is applied to a latch 204 to sample the received bits, and these are progressively de-serialized (by de-serializer 212) at a rate determined by a divided clock derived from the forwarded clock. The receiver side thus re-creates the original data burst.

For the sampling of the received bits to be performed reliably, the forwarded clock should be centered on the data unit interval at the latch 204. However, due to routing and circuit delay imbalances, the forwarded clock may be off-center of the unit interval at the clock input of the latch 204. To enable an area and power efficient design, the forwarded clock on the transmitter 102 comprises the configurable delay circuit 208 to trim the edge of the forwarded clock such that it is aligned at the receiver to center on the composite signal eye of all the data lanes.

The trim setting for the configurable delay circuit 208 may be determined by utilizing a training process. One approach involves sweeping through trim settings on the transmitter side while the receiver measures and communicate a pass/fail result of each setting back to the transmitter 102. The transmitter 102 analyzes pass/fail responses and determine a final optimal (optimal in terms of providing the best results on the values tested in the sweep) trim setting to apply to the configurable delay circuit 208. Another approach is to sweep through trim settings on the transmitter 102 while the receiver 104 tracks the sweep locally and does not communicate per-setting pass/fail results, but rather analyzes the pass/fail results locally to determine a final optimal trim setting. At the end of the sweep, the receiver 104 communicates the optimal trim setting to the transmitter 102, at the transmitter 102 programs the configurable delay circuit 208 with this setting.

Irrespective of which side does the analysis, communication between the transmitter 102 and the receiver 104 is utilized to either indicate pass/fail results or to indicate the final trim setting.

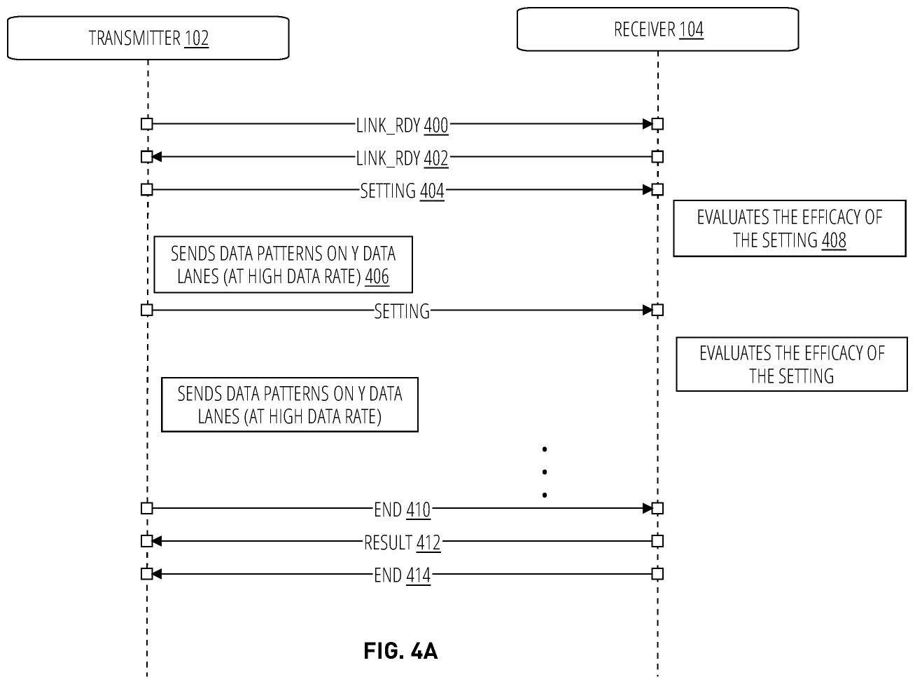

FIG. 3 depicts an in-band messaging process in one embodiment. During the process of ‘training’ (converging on a setting for) a trim value for the configurable delay circuit 208 on the transmitter 102, the N-data lanes are operated to exchange N-bit messages 302 between the transmitter 102 and the receiver 104. The message 302 may be binary encoded to support a suite of 2N-1 unique messages, or one-hot encoded to support a suite of N unique messages.

The number of data lanes N may be greater than the number of bits (precision) of the configurable trim parameter applied to the configurable delay circuit 208 on the transmitter 102.

During the training process, the link remains in an untrained or under-trained state. During this time, particular data patterns may be communicated between the transmitter 102 and the receiver 104 each in multiple unit intervals (e.g., >=3 UI).

In one embodiment, a subset of X<N of the data lanes are utilized to communicate training messages, and another subset Y<N of the data lanes are utilized to communicate values derived from the training process, where Y is the minimum number of bits that are needed to communicate a sweep setting or a trained time value in either binary encoding or one-hot encoding. The number of lanes X for communicating messages is the number of bits needed to communicate the messages 302 for training based on binary or one-hot encoding.

In one embodiment of a training sequence, the trim parameter is swept through a range of values. The effectiveness of the swept value on centering the composite signal eye of the data ranges at the receiver is measured. At the conclusion of the sweep, or after each or some number of trim parameters are evaluated, an optimal trim value is determined and the configurable delay circuit 208 is configured with this value. The determination of the optimal trim value to apply at the configurable delay circuit 208 may be performed at the transmitter 102 or at the receiver 104.

In different implementations, the trim setting may be updated during the sweep each time a value providing improved results is identified; or, the entire sweep may be performed, and the optimal trim setting thereby identified may be set at the conclusion of the sweep.

An exemplary suite of message 302 to implement this algorithm is provided in Table 1 below.

TABLE 1

| Message | Direction | Description |
|---|---|---|
| LINK_RDY | TX to RX, | Component ready to begin training |
| | RX to TX | |
| SETTING | TX to RX | Next trim training parameter ready |
| RESULT | RX to TX | An intermediate result of measuring the |
| | | effect of the trim parameter, or a final |
| | | optimal trim parameter |
| END | TX to RX, | Training complete |
| | RX to TX | |
| ERR | RX to TX | Training failed |

The suite of messages 302 depicted in Table 1 may enable any of a variety of sweep training algorithms to be utilized, depending on the implementation. Additional or different messages may be utilized depending on the nature of the implementation.

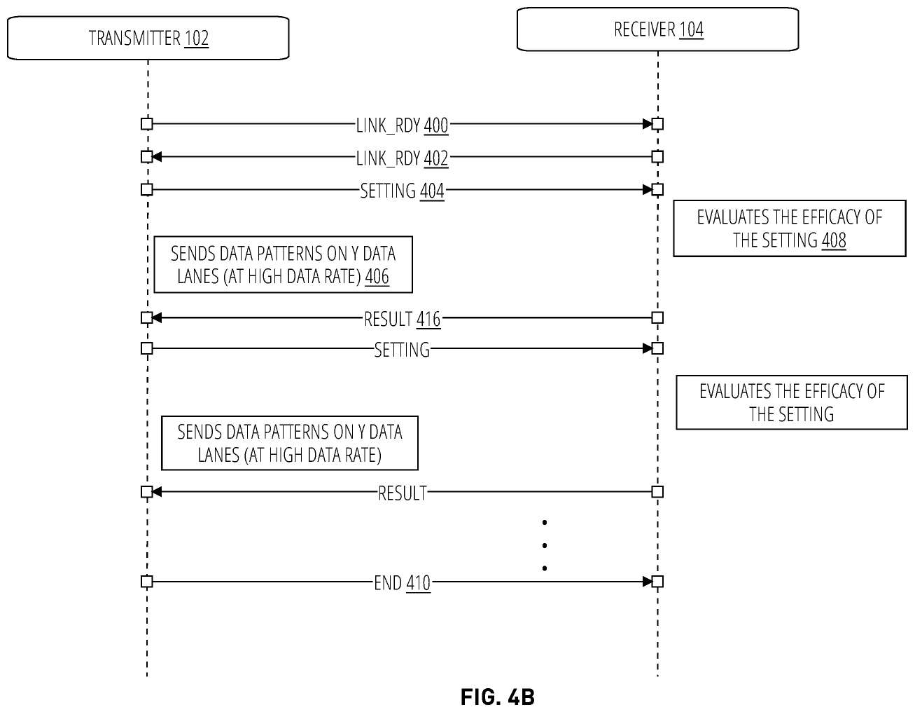

FIG. 4A depicts a training process for link configuration in one embodiment.

Variations of this process will be readily apparent to those of skill in the art in view of this disclosure.

The transmitter 102 initiates training (LINK_RDY 400) and the receiver 104 confirms that it is ready (LINK_RDY 402). The transmitter 102 messages the receiver to begin testing the efficacy of the first trim setting in the sweep (SETTING 404). The transmitter 102 sends data patterns on Y data lanes (at high data rate) 406 and the receiver 104 evaluates the efficacy of the setting 408. In some embodiments, the transmitter 102 may accompany the SETTING 404 with a trim value or index communicated over the data lanes, with which the receiver 104 associates results of evaluating the setting. In other embodiments, the receiver may shadow the sweep and maintain a set of sweep indexes and efficacies, from which it determines the most optimal of the trim settings to report back to the transmitter 102 at the conclusion of training.

The process of sweeping through configurable delay circuit 208 settings and evaluating their efficacy continues, until the transmitter 102 informs the receiver 104 that training has concluded (END 410). The receiver 104 then communicates (over the Y data lanes) the delay value (RESULT 412) that tested as optimal and (optionally) may acknowledge the conclusion of training (END 414).

FIG. 4B depicts a training process for link configuration in another embodiment, in which the receiver 104 communicates results of evaluating trim settings back to the transmitter 102 (RESULT 416). In this embodiment, the transmitter 102 determines the optimal trim setting at the conclusion of the sweep.

The mechanisms disclosed herein may be utilized by computing devices comprising one or more graphic processing unit (GPU) and/or general purpose data processor (e.g., a ‘central processing unit or CPU). Exemplary architectures will now be described that may be configured to utilize the mechanisms disclosed herein on such devices.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

### Parallel Processing Unit

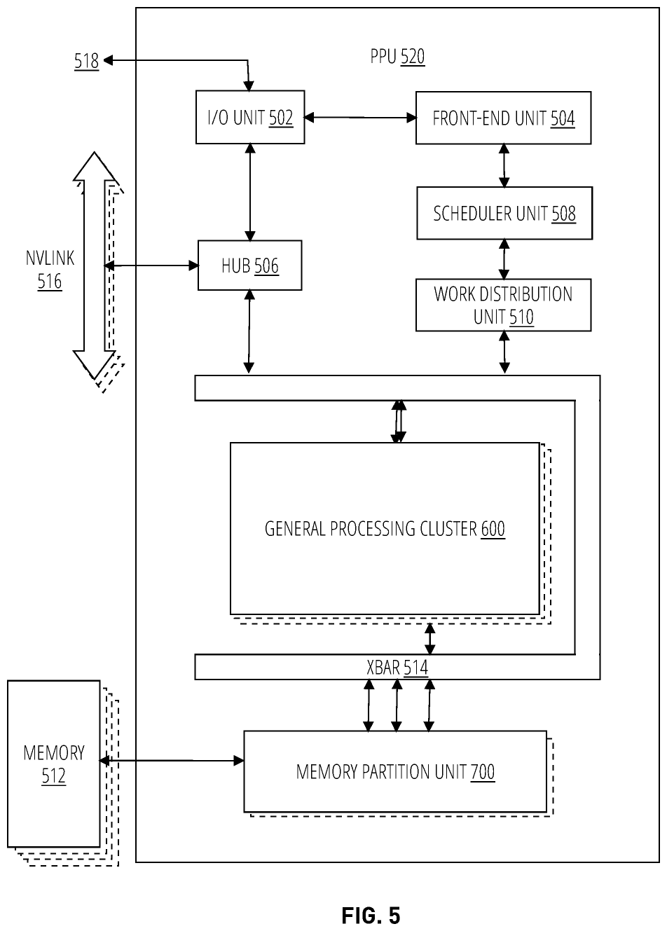

FIG. 5 depicts a parallel processing unit 520, in accordance with an embodiment. In an embodiment, the parallel processing unit 520 is a multi-threaded processor that is implemented on one or more integrated circuit devices. The parallel processing unit 520 is a latency hiding architecture designed to process many threads in parallel. A thread (e.g., a thread of execution) is an instantiation of a set of instructions configured to be executed by the parallel processing unit 520. In an embodiment, the parallel processing unit 520 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 520 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 520 modules may be configured to accelerate thousands of High Performance Computing (HPC), data center, and machine learning applications. The parallel processing unit 520 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 5, the parallel processing unit 520 includes an I/O unit 502, a front-end unit 504, a scheduler unit 508, a work distribution unit 510, a hub 506, a crossbar 514, one or more general processing cluster 600 modules, and one or more memory partition unit 700 modules. The parallel processing unit 520 may be connected to a host processor or other parallel processing unit 520 modules via one or more high-speed NVLink 516 interconnects. The parallel processing unit 520 may be connected to a host processor or other peripheral devices via an interconnect 518. The parallel processing unit 520 may also be connected to a local memory comprising a number of memory 512 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 512 may comprise logic to configure the parallel processing unit 520 to carry out aspects of the techniques disclosed herein.

By way of example, embodiments of the NVLink 516, hub 506, and/or crossbar 514 may implement the mechanisms disclosed herein.

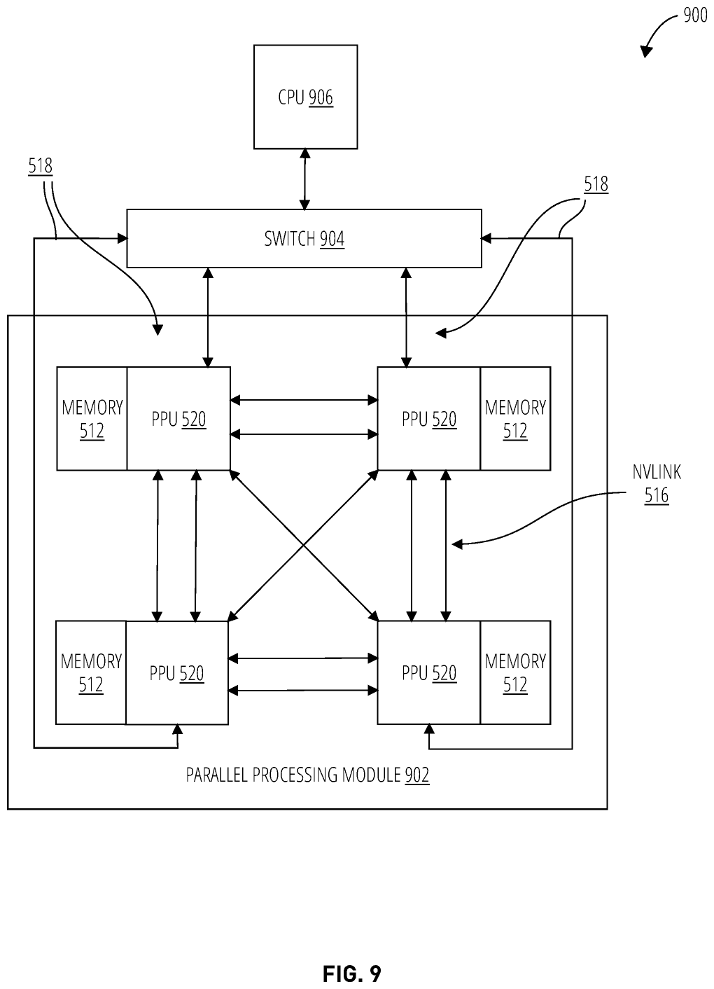

The NVLink 516 interconnect enables systems to scale and include one or more parallel processing unit 520 modules combined with one or more CPUs, supports cache coherence between the parallel processing unit 520 modules and CPUs, and CPU mastering. Data and/or commands may be transmitted by the NVLink 516 through the hub 506 to/from other units of the parallel processing unit 520 such as one or more copy engines, a video encoder, a video decoder, a power management unit, etc. (not explicitly shown). The NVLink 516 is described in more detail in conjunction with FIG. 9.

The I/O unit 502 is configured to transmit and receive communications (e.g., commands, data, etc.) from a host processor (not shown) over the interconnect 518. The I/O unit 502 may communicate with the host processor directly via the interconnect 518 or through one or more intermediate devices such as a memory bridge. In an embodiment, the I/O unit 502 may communicate with one or more other processors, such as one or more parallel processing unit 520 modules via the interconnect 518. In an embodiment, the I/O unit 502 implements a Peripheral Component Interconnect Express (PCIe) interface for communications over a PCIe bus and the interconnect 518 is a PCIe bus. In alternative embodiments, the I/O unit 502 may implement other types of well-known interfaces for communicating with external devices.

The I/O unit 502 decodes packets received via the interconnect 518. In an embodiment, the packets represent commands configured to cause the parallel processing unit 520 to perform various operations. The I/O unit 502 transmits the decoded commands to various other units of the parallel processing unit 520 as the commands may specify. For example, some commands may be transmitted to the front-end unit 504. Other commands may be transmitted to the hub 506 or other units of the parallel processing unit 520 such as one or more copy engines, a video encoder, a video decoder, a power management unit, etc. (not explicitly shown). In other words, the I/O unit 502 is configured to route communications between and among the various logical units of the parallel processing unit 520.

In an embodiment, a program executed by the host processor encodes a command stream in a buffer that provides workloads to the parallel processing unit 520 for processing. A workload may comprise several instructions and data to be processed by those instructions. The buffer is a region in a memory that is accessible (e.g., read/write) by both the host processor and the parallel processing unit 520. For example, the I/O unit 502 may be configured to access the buffer in a system memory connected to the interconnect 518 via memory requests transmitted over the interconnect 518. In an embodiment, the host processor writes the command stream to the buffer and then transmits a pointer to the start of the command stream to the parallel processing unit 520. The front-end unit 504 receives pointers to one or more command streams. The front-end unit 504 manages the one or more streams, reading commands from the streams and forwarding commands to the various units of the parallel processing unit 520.

The front-end unit 504 is coupled to a scheduler unit 508 that configures the various general processing cluster 600 modules to process tasks defined by the one or more streams. The scheduler unit 508 is configured to track state information related to the various tasks managed by the scheduler unit 508. The state may indicate which general processing cluster 600 a task is assigned to, whether the task is active or inactive, a priority level associated with the task, and so forth. The scheduler unit 508 manages the execution of a plurality of tasks on the one or more general processing cluster 600 modules.

The scheduler unit 508 is coupled to a work distribution unit 510 that is configured to dispatch tasks for execution on the general processing cluster 600 modules. The work distribution unit 510 may track a number of scheduled tasks received from the scheduler unit 508. In an embodiment, the work distribution unit 510 manages a pending task pool and an active task pool for each of the general processing cluster 600 modules. The pending task pool may comprise a number of slots (e.g., 32 slots) that contain tasks assigned to be processed by a particular general processing cluster 600. The active task pool may comprise a number of slots (e.g., 4 slots) for tasks that are actively being processed by the general processing cluster 600 modules. As a general processing cluster 600 finishes the execution of a task, that task is evicted from the active task pool for the general processing cluster 600 and one of the other tasks from the pending task pool is selected and scheduled for execution on the general processing cluster 600. If an active task has been idle on the general processing cluster 600, such as while waiting for a data dependency to be resolved, then the active task may be evicted from the general processing cluster 600 and returned to the pending task pool while another task in the pending task pool is selected and scheduled for execution on the general processing cluster 600.

The work distribution unit 510 communicates with the one or more general processing cluster 600 modules via crossbar 514. The crossbar 514 is an interconnect network that couples many of the units of the parallel processing unit 520 to other units of the parallel processing unit 520. For example, the crossbar 514 may be configured to couple the work distribution unit 510 to a particular general processing cluster 600. Although not shown explicitly, one or more other units of the parallel processing unit 520 may also be connected to the crossbar 514 via the hub 506.

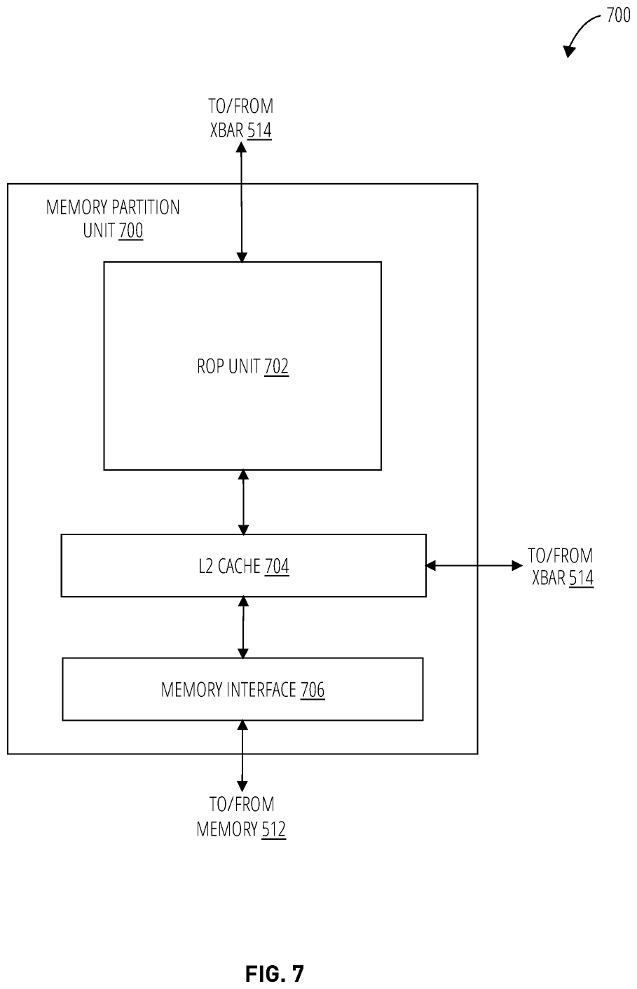

The tasks are managed by the scheduler unit 508 and dispatched to a general processing cluster 600 by the work distribution unit 510. The general processing cluster 600 is configured to process the task and generate results. The results may be consumed by other tasks within the general processing cluster 600, routed to a different general processing cluster 600 via the crossbar 514, or stored in the memory 512. The results can be written to the memory 512 via the memory partition unit 700 modules, which implement a memory interface for reading and writing data to/from the memory 512. The results can be transmitted to another parallel processing unit 520 or CPU via the NVLink 516. In an embodiment, the parallel processing unit 520 includes a number U of memory partition unit 700 modules that is equal to the number of separate and distinct memory 512 devices coupled to the parallel processing unit 520. A memory partition unit 700 will be described in more detail below in conjunction with FIG. 7.

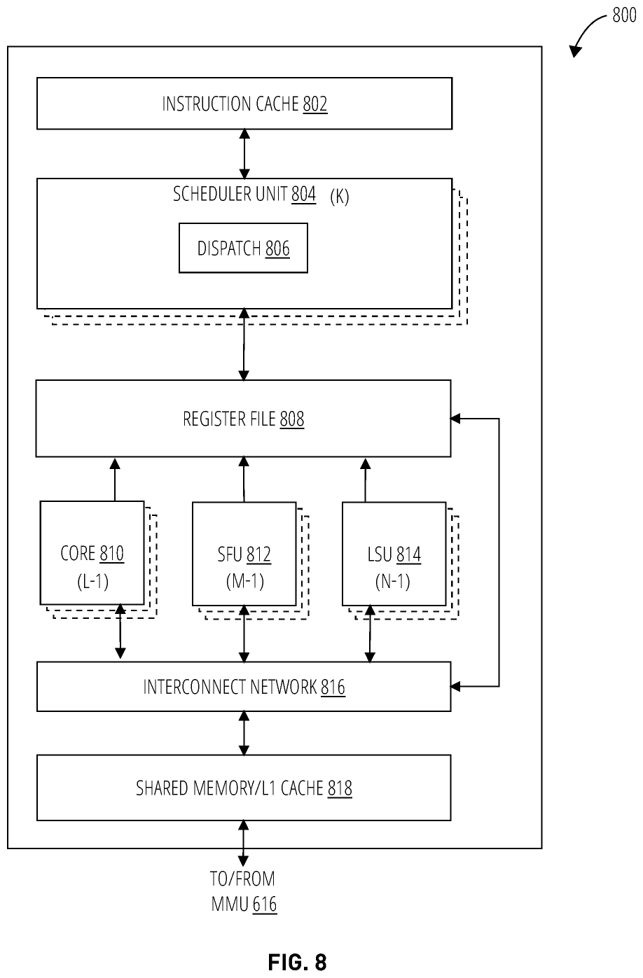

In an embodiment, a host processor executes a driver kernel that implements an application programming interface (API) that enables one or more applications executing on the host processor to schedule operations for execution on the parallel processing unit 520. In an embodiment, multiple compute applications are simultaneously executed by the parallel processing unit 520 and the parallel processing unit 520 provides isolation, quality of service (QoS), and independent address spaces for the multiple compute applications. An application may generate instructions (e.g., API calls) that cause the driver kernel to generate one or more tasks for execution by the parallel processing unit 520. The driver kernel outputs tasks to one or more streams being processed by the parallel processing unit 520. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 8.

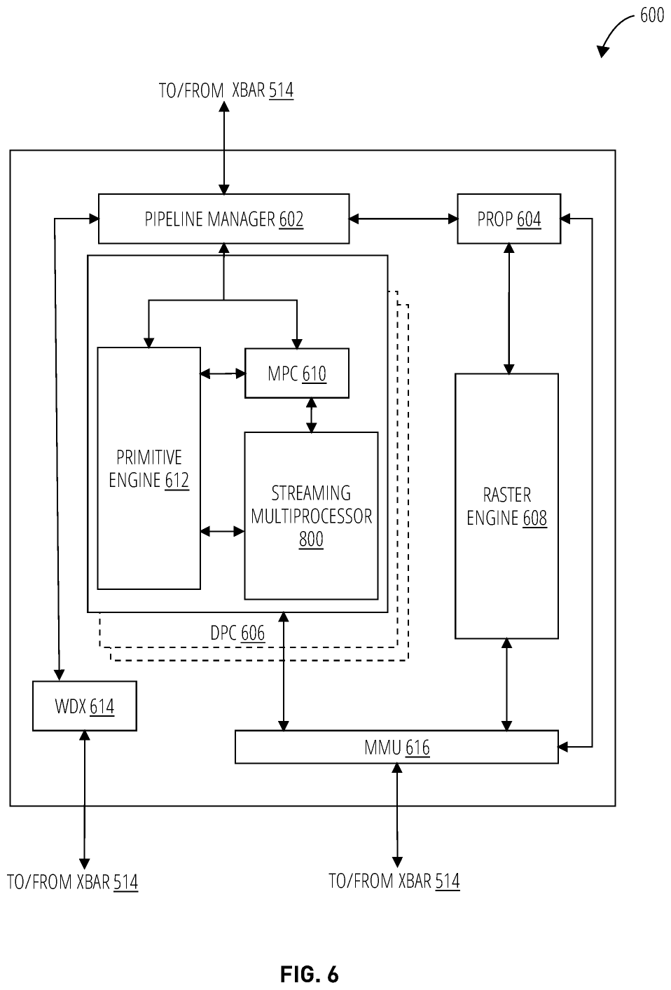

FIG. 6 depicts a general processing cluster 600 of the parallel processing unit 520 of FIG. 5, in accordance with an embodiment. As shown in FIG. 6, each general processing cluster 600 includes a number of hardware units for processing tasks. In an embodiment, each general processing cluster 600 includes a pipeline manager 602, a pre-raster operations unit 604, a raster engine 608, a work distribution crossbar 614, a memory management unit 616, and one or more data processing cluster 606. It will be appreciated that the general processing cluster 600 of FIG. 6 may include other hardware units in lieu of or in addition to the units shown in FIG. 6.

In an embodiment, the operation of the general processing cluster 600 is controlled by the pipeline manager 602. The pipeline manager 602 manages the configuration of the one or more data processing cluster 606 modules for processing tasks allocated to the general processing cluster 600. In an embodiment, the pipeline manager 602 may configure at least one of the one or more data processing cluster 606 modules to implement at least a portion of a graphics rendering pipeline. For example, a data processing cluster 606 may be configured to execute a vertex shader program on the programmable streaming multiprocessor 800. The pipeline manager 602 may also be configured to route packets received from the work distribution unit 510 to the appropriate logical units within the general processing cluster 600. For example, some packets may be routed to fixed function hardware units in the pre-raster operations unit 604 and/or raster engine 608 while other packets may be routed to the data processing cluster 606 modules for processing by the primitive engine 612 or the streaming multiprocessor 800. In an embodiment, the pipeline manager 602 may configure at least one of the one or more data processing cluster 606 modules to implement a neural network model and/or a computing pipeline.

The pre-raster operations unit 604 is configured to route data generated by the raster engine 608 and the data processing cluster 606 modules to a Raster Operations (ROP) unit, described in more detail in conjunction with FIG. 7. The pre-raster operations unit 604 may also be configured to perform optimizations for color blending, organize pixel data, perform address translations, and the like.

The raster engine 608 includes a number of fixed function hardware units configured to perform various raster operations. In an embodiment, the raster engine 608 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 608 comprises fragments to be processed, for example, by a fragment shader implemented within a data processing cluster 606.

Each data processing cluster 606 included in the general processing cluster 600 includes an M-pipe controller 610, a primitive engine 612, and one or more streaming multiprocessor 800 modules. The M-pipe controller 610 controls the operation of the data processing cluster 606, routing packets received from the pipeline manager 602 to the appropriate units in the data processing cluster 606. For example, packets associated with a vertex may be routed to the primitive engine 612, which is configured to fetch vertex attributes associated with the vertex from the memory 512. In contrast, packets associated with a shader program may be transmitted to the streaming multiprocessor 800.

The streaming multiprocessor 800 comprises a programmable streaming processor that is configured to process tasks represented by a number of threads. Each streaming multiprocessor 800 is multi-threaded and configured to execute a plurality of threads (e.g., 32 threads) from a particular group of threads concurrently. In an embodiment, the streaming multiprocessor 800 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 800 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 800 will be described in more detail below in conjunction with FIG. 8.

The memory management unit 616 provides an interface between the general processing cluster 600 and the memory partition unit 700. The memory management unit 616 may provide translation of virtual addresses into physical addresses, memory protection, and arbitration of memory requests. In an embodiment, the memory management unit 616 provides one or more translation lookaside buffers (TLBs) for performing translation of virtual addresses into physical addresses in the memory 512.

FIG. 7 depicts a memory partition unit 700 of the parallel processing unit 520 of FIG. 5, in accordance with an embodiment. As shown in FIG. 7, the memory partition unit 700 includes a raster operations unit 702, a level two cache 704, and a memory interface 706. The memory interface 706 is coupled to the memory 512. Memory interface 706 may implement 32, 64, 128, 1024-bit data buses, or the like, for high-speed data transfer. In an embodiment, the parallel processing unit 520 incorporates U memory interface 706 modules, one memory interface 706 per pair of memory partition unit 700 modules, where each pair of memory partition unit 700 modules is connected to a corresponding memory 512 device. For example, parallel processing unit 520 may be connected to up to Y memory 512 devices, such as high bandwidth memory stacks or graphics double-data-rate, version 5, synchronous dynamic random access memory, or other types of persistent storage.

In an embodiment, the memory interface 706 implements an HBM2 memory interface and Y equals half U. In an embodiment, the HBM2 memory stacks are located on the same physical package as the parallel processing unit 520, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 512 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 520 modules process very large datasets and/or run applications for extended periods.

In an embodiment, the parallel processing unit 520 implements a multi-level memory hierarchy. In an embodiment, the memory partition unit 700 supports a unified memory to provide a single unified virtual address space for CPU and parallel processing unit 520 memory, enabling data sharing between virtual memory systems. In an embodiment the frequency of accesses by a parallel processing unit 520 to memory located on other processors is traced to ensure that memory pages are moved to the physical memory of the parallel processing unit 520 that is accessing the pages more frequently. In an embodiment, the NVLink 516 supports address translation services allowing the parallel processing unit 520 to directly access a CPU's page tables and providing full access to CPU memory by the parallel processing unit 520.

In an embodiment, copy engines transfer data between multiple parallel processing unit 520 modules or between parallel processing unit 520 modules and CPUs. The copy engines can generate page faults for addresses that are not mapped into the page tables. The memory partition unit 700 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 512 or other system memory may be fetched by the memory partition unit 700 and stored in the level two cache 704, which is located on-chip and is shared between the various general processing cluster 600 modules. As shown, each memory partition unit 700 includes a portion of the level two cache 704 associated with a corresponding memory 512 device. Lower level caches may then be implemented in various units within the general processing cluster 600 modules. For example, each of the streaming multiprocessor 800 modules may implement an L1 cache. The L1 cache is private memory that is dedicated to a particular streaming multiprocessor 800. Data from the level two cache 704 may be fetched and stored in each of the L1 caches for processing in the functional units of the streaming multiprocessor 800 modules. The level two cache 704 is coupled to the memory interface 706 and the crossbar 514.

The raster operations unit 702 performs graphics raster operations related to pixel color, such as color compression, pixel blending, and the like. The raster operations unit 702 also implements depth testing in conjunction with the raster engine 608, receiving a depth for a sample location associated with a pixel fragment from the culling engine of the raster engine 608. The depth is tested against a corresponding depth in a depth buffer for a sample location associated with the fragment. If the fragment passes the depth test for the sample location, then the raster operations unit 702 updates the depth buffer and transmits a result of the depth test to the raster engine 608. It will be appreciated that the number of partition memory partition unit 700 modules may be different than the number of general processing cluster 600 modules and, therefore, each raster operations unit 702 may be coupled to each of the general processing cluster 600 modules. The raster operations unit 702 tracks packets received from the different general processing cluster 600 modules and determines which general processing cluster 600 that a result generated by the raster operations unit 702 is routed to through the crossbar 514. Although the raster operations unit 702 is included within the memory partition unit 700 in FIG. 7, in other embodiment, the raster operations unit 702 may be outside of the memory partition unit 700. For example, the raster operations unit 702 may reside in the general processing cluster 600 or another unit.

FIG. 8 illustrates the streaming multiprocessor 800 of FIG. 6, in accordance with an embodiment. As shown in FIG. 8, the streaming multiprocessor 800 includes an instruction cache 802, one or more scheduler unit 804 modules (e.g., such as scheduler unit 508), a register file 808, one or more processing core 810 modules, one or more special function unit 812 modules, one or more load/store unit 814 modules, an interconnect network 816, and a shared memory/L1 cache 818. By way of example, embodiments of the interconnect network 816 may implement the mechanisms disclosed herein.

As described above, the work distribution unit 510 dispatches tasks for execution on the general processing cluster 600 modules of the parallel processing unit 520. The tasks are allocated to a particular data processing cluster 606 within a general processing cluster 600 and, if the task is associated with a shader program, the task may be allocated to a streaming multiprocessor 800. The scheduler unit 508 receives the tasks from the work distribution unit 510 and manages instruction scheduling for one or more thread blocks assigned to the streaming multiprocessor 800. The scheduler unit 804 schedules thread blocks for execution as warps of parallel threads, where each thread block is allocated at least one warp. In an embodiment, each warp executes 32 threads. The scheduler unit 804 may manage a plurality of different thread blocks, allocating the warps to the different thread blocks and then dispatching instructions from the plurality of different cooperative groups to the various functional units (e.g., core 810 modules, special function unit 812 modules, and load/store unit 814 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 806 unit is configured within the scheduler unit 804 to transmit instructions to one or more of the functional units. In one embodiment, the scheduler unit 804 includes two dispatch 806 units that enable two different instructions from the same warp to be dispatched during each clock cycle. In alternative embodiments, each scheduler unit 804 may include a single dispatch 806 unit or additional dispatch 806 units.

Each streaming multiprocessor 800 includes a register file 808 that provides a set of registers for the functional units of the streaming multiprocessor 800. In an embodiment, the register file 808 is divided between each of the functional units such that each functional unit is allocated a dedicated portion of the register file 808. In another embodiment, the register file 808 is divided between the different warps being executed by the streaming multiprocessor 800. The register file 808 provides temporary storage for operands connected to the data paths of the functional units.

Each streaming multiprocessor 800 comprises L processing core 810 modules. In an embodiment, the streaming multiprocessor 800 includes a large number (e.g., 128, etc.) of distinct processing core 810 modules. Each core 810 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 810 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 810 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 800 also comprises M special function unit 812 modules that perform special functions (e.g., attribute evaluation, reciprocal square root, and the like). In an embodiment, the special function unit 812 modules may include a tree traversal unit configured to traverse a hierarchical tree data structure. In an embodiment, the special function unit 812 modules may include texture unit configured to perform texture map filtering operations. In an embodiment, the texture units are configured to load texture maps (e.g., a 2D array of texels) from the memory 512 and sample the texture maps to produce sampled texture values for use in shader programs executed by the streaming multiprocessor 800. In an embodiment, the texture maps are stored in the shared memory/L1 cache 818. The texture units implement texture operations such as filtering operations using mip-maps (e.g., texture maps of varying levels of detail). In an embodiment, each streaming multiprocessor 800 includes two texture units.

Each streaming multiprocessor 800 also comprises N load/store unit 814 modules that implement load and store operations between the shared memory/L1 cache 818 and the register file 808. Each streaming multiprocessor 800 includes an interconnect network 816 that connects each of the functional units to the register file 808 and the load/store unit 814 to the register file 808 and shared memory/L1 cache 818. In an embodiment, the interconnect network 816 is a crossbar that can be configured to connect any of the functional units to any of the registers in the register file 808 and connect the load/store unit 814 modules to the register file 808 and memory locations in shared memory/L1 cache 818.

The shared memory/L1 cache 818 is an array of on-chip memory that allows for data storage and communication between the streaming multiprocessor 800 and the primitive engine 612 and between threads in the streaming multiprocessor 800. In an embodiment, the shared memory/L1 cache 818 comprises 128 KB of storage capacity and is in the path from the streaming multiprocessor 800 to the memory partition unit 700. The shared memory/L1 cache 818 can be used to cache reads and writes. One or more of the shared memory/L1 cache 818, level two cache 704, and memory 512 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 818 enables the shared memory/L1 cache 818 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 5, are bypassed, creating a much simpler programming model. In the general purpose parallel computation configuration, the work distribution unit 510 assigns and distributes blocks of threads directly to the data processing cluster 606 modules. The threads in a block execute the same program, using a unique thread ID in the calculation to ensure each thread generates unique results, using the streaming multiprocessor 800 to execute the program and perform calculations, shared memory/L1 cache 818 to communicate between threads, and the load/store unit 814 to read and write global memory through the shared memory/L1 cache 818 and the memory partition unit 700. When configured for general purpose parallel computation, the streaming multiprocessor 800 can also write commands that the scheduler unit 508 can use to launch new work on the data processing cluster 606 modules.

The parallel processing unit 520 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 520 is embodied on a single semiconductor substrate. In another embodiment, the parallel processing unit 520 is included in a system-on-a-chip (SoC) along with one or more other devices such as additional parallel processing unit 520 modules, the memory 512, a reduced instruction set computer (RISC) CPU, a memory management unit (MMU), a digital-to-analog converter (DAC), and the like.

In an embodiment, the parallel processing unit 520 may be included on a graphics card that includes one or more memory devices. The graphics card may be configured to interface with a PCIe slot on a motherboard of a desktop computer. In yet another embodiment, the parallel processing unit 520 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 9 is a conceptual diagram of a processing system 900 implemented using the parallel processing unit 520 of FIG. 5, in accordance with an embodiment. The processing system 900 includes a central processing unit 906, switch 904, and multiple parallel processing unit 520 modules each and respective memory 512 modules. The NVLink 516 provides high-speed communication links between each of the parallel processing unit 520 modules. Although a particular number of NVLink 516 and interconnect 518 connections are illustrated in FIG. 9, the number of connections to each parallel processing unit 520 and the central processing unit 906 may vary. The switch 904 interfaces between the interconnect 518 and the central processing unit 906. The parallel processing unit 520 modules, memory 512 modules, and NVLink 516 connections may be situated on a single semiconductor platform to form a parallel processing module 902. In an embodiment, the switch 904 supports two or more protocols to interface between various different connections and/or links.

In another embodiment (not shown), the NVLink 516 provides one or more high-speed communication links between each of the parallel processing unit modules (parallel processing unit 520, parallel processing unit 520, parallel processing unit 520, and parallel processing unit 520) and the central processing unit 906 and the switch 904 interfaces between the interconnect 518 and each of the parallel processing unit modules. The parallel processing unit modules, memory 512 modules, and interconnect 518 may be situated on a single semiconductor platform to form a parallel processing module 902. In yet another embodiment (not shown), the interconnect 518 provides one or more communication links between each of the parallel processing unit modules and the central processing unit 906 and the switch 904 interfaces between each of the parallel processing unit modules using the NVLink 516 to provide one or more high-speed communication links between the parallel processing unit modules. In another embodiment (not shown), the NVLink 516 provides one or more high-speed communication links between the parallel processing unit modules and the central processing unit 906 through the switch 904. In yet another embodiment (not shown), the interconnect 518 provides one or more communication links between each of the parallel processing unit modules directly. One or more of the NVLink 516 high-speed communication links may be implemented as a physical NVLink interconnect or either an on-chip or on-die interconnect using the same protocol as the NVLink 516.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 902 may be implemented as a circuit board substrate and each of the parallel processing unit modules and/or memory 512 modules may be packaged devices. In an embodiment, the central processing unit 906, switch 904, and the parallel processing module 902 are situated on a single semiconductor platform.

In an embodiment, the signaling rate of each NVLink 516 is 20 to 25 Gigabits/second and each parallel processing unit module includes six NVLink 516 interfaces (as shown in FIG. 9, five NVLink 516 interfaces are included for each parallel processing unit module). Each NVLink 516 provides a data transfer rate of 25 Gigabytes/second in each direction, with six links providing 300 Gigabytes/second. The NVLink 516 can be used exclusively for PPU-to-PPU communication as shown in FIG. 9, or some combination of PPU-to-PPU and PPU-to-CPU, when the central processing unit 906 also includes one or more NVLink 516 interfaces.

In an embodiment, the NVLink 516 allows direct load/store/atomic access from the central processing unit 906 to each parallel processing unit module's memory 512. In an embodiment, the NVLink 516 supports coherency operations, allowing data read from the memory 512 modules to be stored in the cache hierarchy of the central processing unit 906, reducing cache access latency for the central processing unit 906. In an embodiment, the NVLink 516 includes support for Address Translation Services (ATS), enabling the parallel processing unit module to directly access page tables within the central processing unit 906. One or more of the NVLink 516 may also be configured to operate in a low-power mode.

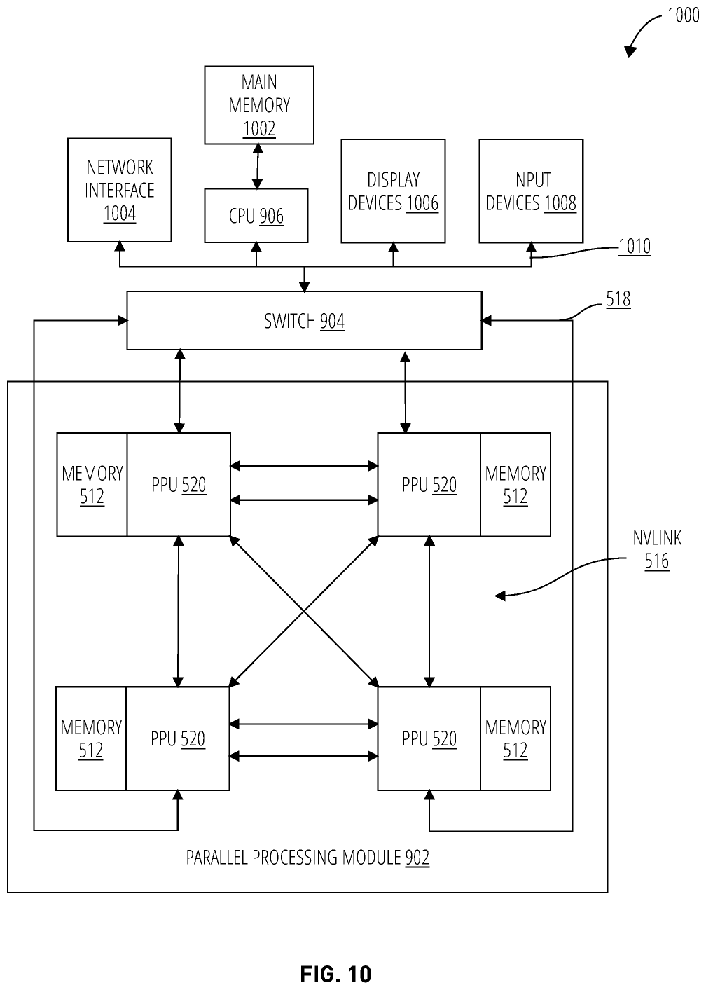

FIG. 10 depicts an exemplary processing system 1000 in which the various architecture and/or functionality of the various previous embodiments may be implemented. As shown, an exemplary processing system 1000 is provided including at least one central processing unit 906 that is connected to a communications bus 1010. The communication communications bus 1010 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 1000 also includes a main memory 1002. Control logic (software) and data are stored in the main memory 1002 which may take the form of random access memory (RAM).

The exemplary processing system 1000 also includes input devices 1008, the parallel processing module 902, and display devices 1006, e.g. a conventional CRT (cathode ray tube), LCD (liquid crystal display), LED (light emitting diode), plasma display or the like. User input may be received from the input devices 1008, e.g., keyboard, mouse, touchpad, microphone, and the like. Each of the foregoing modules and/or devices may even be situated on a single semiconductor platform to form the exemplary processing system 1000. Alternately, the various modules may also be situated separately or in various combinations of semiconductor platforms per the desires of the user.

Further, the exemplary processing system 1000 may be coupled to a network (e.g., a telecommunications network, local area network (LAN), wireless network, wide area network (WAN) such as the Internet, peer-to-peer network, cable network, or the like) through a network interface 1004 for communication purposes.

The exemplary processing system 1000 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1002 and/or the secondary storage. Such computer programs, when executed, enable the exemplary processing system 1000 to perform various functions. The main memory 1002, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 1000 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Graphics Processing Pipeline

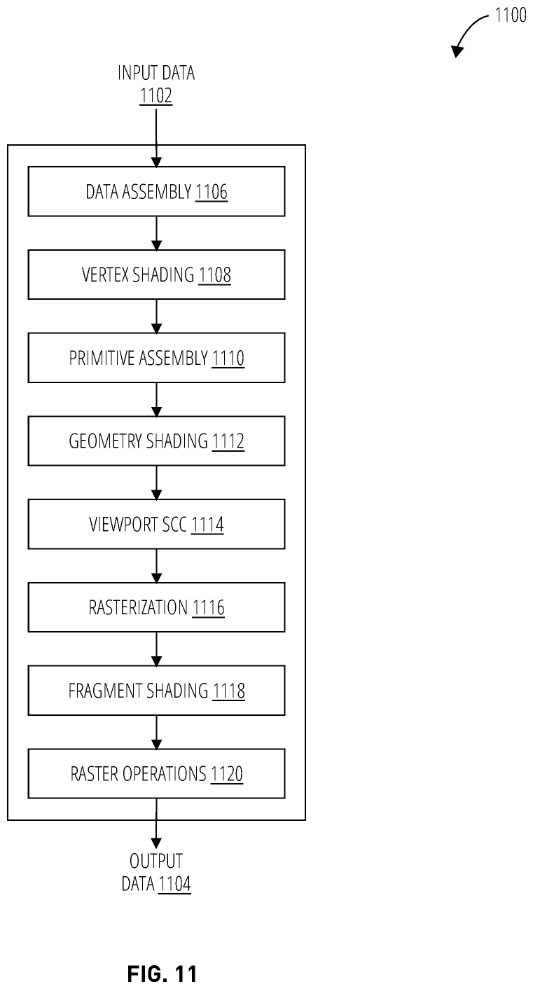

FIG. 11 is a conceptual diagram of a graphics processing pipeline 1100 implemented by the parallel processing unit 520 of FIG. 5, in accordance with an embodiment. In an embodiment, the parallel processing unit 520 comprises a graphics processing unit (GPU). The parallel processing unit 520 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The parallel processing unit 520 can be configured to process the graphics primitives to generate a frame buffer (e.g., pixel data for each of the pixels of the display).

An application writes model data for a scene (e.g., a collection of vertices and attributes) to a memory such as a system memory or memory 512. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the streaming multiprocessor 800 modules of the parallel processing unit 520 including one or more of a vertex shader, hull shader, domain shader, geometry shader, and a pixel shader. For example, one or more of the streaming multiprocessor 800 modules may be configured to execute a vertex shader program that processes a number of vertices defined by the model data. In an embodiment, the different streaming multiprocessor 800 modules may be configured to execute different shader programs concurrently. For example, a first subset of streaming multiprocessor 800 modules may be configured to execute a vertex shader program while a second subset of streaming multiprocessor 800 modules may be configured to execute a pixel shader program. The first subset of streaming multiprocessor 800 modules processes vertex data to produce processed vertex data and writes the processed vertex data to the level two cache 704 and/or the memory 512. After the processed vertex data is rasterized (e.g., transformed from three-dimensional data into two-dimensional data in screen space) to produce fragment data, the second subset of streaming multiprocessor 800 modules executes a pixel shader to produce processed fragment data, which is then blended with other processed fragment data and written to the frame buffer in memory 512. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline 1100 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 1100 receives input data 601 that is transmitted from one stage to the next stage of the graphics processing pipeline 1100 to generate output data 1104. In an embodiment, the graphics processing pipeline 1100 may represent a graphics processing pipeline defined by the OpenGL® API. As an option, the graphics processing pipeline 1100 may be implemented in the context of the functionality and architecture of the previous Figures and/or any subsequent Figure(s).

As shown in FIG. 11, the graphics processing pipeline 1100 comprises a pipeline architecture that includes a number of stages. The stages include, but are not limited to, a data assembly 1106 stage, a vertex shading 1108 stage, a primitive assembly 1110 stage, a geometry shading 1112 stage, a viewport SCC 1114 stage, a rasterization 1116 stage, a fragment shading 1118 stage, and a raster operations 1120 stage. In an embodiment, the input data 1102 comprises commands that configure the processing units to implement the stages of the graphics processing pipeline 1100 and geometric primitives (e.g., points, lines, triangles, quads, triangle strips or fans, etc.) to be processed by the stages. The output data 1104 may comprise pixel data (e.g., color data) that is copied into a frame buffer or other type of surface data structure in a memory.

The data assembly 1106 stage receives the input data 1102 that specifies vertex data for high-order surfaces, primitives, or the like. The data assembly 1106 stage collects the vertex data in a temporary storage or queue, such as by receiving a command from the host processor that includes a pointer to a buffer in memory and reading the vertex data from the buffer. The vertex data is then transmitted to the vertex shading 1108 stage for processing.

The vertex shading 1108 stage processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading 1108 stage may manipulate individual vertex attributes such as position, color, texture coordinates, and the like. In other words, the vertex shading 1108 stage performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading 1108 stage generates transformed vertex data that is transmitted to the primitive assembly 1110 stage.

The primitive assembly 1110 stage collects vertices output by the vertex shading 1108 stage and groups the vertices into geometric primitives for processing by the geometry shading 1112 stage. For example, the primitive assembly 1110 stage may be configured to group every three consecutive vertices as a geometric primitive (e.g., a triangle) for transmission to the geometry shading 1112 stage. In some embodiments, specific vertices may be reused for consecutive geometric primitives (e.g., two consecutive triangles in a triangle strip may share two vertices). The primitive assembly 1110 stage transmits geometric primitives (e.g., a collection of associated vertices) to the geometry shading 1112 stage.

The geometry shading 1112 stage processes geometric primitives by performing a set of operations (e.g., a geometry shader or program) on the geometric primitives. Tessellation operations may generate one or more geometric primitives from each geometric primitive. In other words, the geometry shading 1112 stage may subdivide each geometric primitive into a finer mesh of two or more geometric primitives for processing by the rest of the graphics processing pipeline 1100. The geometry shading 1112 stage transmits geometric primitives to the viewport SCC 1114 stage.

In an embodiment, the graphics processing pipeline 1100 may operate within a streaming multiprocessor and the vertex shading 1108 stage, the primitive assembly 1110 stage, the geometry shading 1112 stage, the fragment shading 1118 stage, and/or hardware/software associated therewith, may sequentially perform processing operations. Once the sequential processing operations are complete, in an embodiment, the viewport SCC 1114 stage may utilize the data. In an embodiment, primitive data processed by one or more of the stages in the graphics processing pipeline 1100 may be written to a cache (e.g. L1 cache, a vertex cache, etc.). In this case, in an embodiment, the viewport SCC 1114 stage may access the data in the cache. In an embodiment, the viewport SCC 1114 stage and the rasterization 1116 stage are implemented as fixed function circuitry.

The viewport SCC 1114 stage performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization 1116 stage.

The rasterization 1116 stage converts the 3D geometric primitives into 2D fragments (e.g. capable of being utilized for display, etc.). The rasterization 1116 stage may be configured to utilize the vertices of the geometric primitives to setup a set of plane equations from which various attributes can be interpolated. The rasterization 1116 stage may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization 1116 stage generates fragment data (e.g., interpolated vertex attributes associated with a particular sample location for each covered pixel) that are transmitted to the fragment shading 1118 stage.

The fragment shading 1118 stage processes fragment data by performing a set of operations (e.g., a fragment shader or a program) on each of the fragments. The fragment shading 1118 stage may generate pixel data (e.g., color values) for the fragment such as by performing lighting operations or sampling texture maps using interpolated texture coordinates for the fragment. The fragment shading 1118 stage generates pixel data that is transmitted to the raster operations 1120 stage.

The raster operations 1120 stage may perform various operations on the pixel data such as performing alpha tests, stencil tests, and blending the pixel data with other pixel data corresponding to other fragments associated with the pixel. When the raster operations 1120 stage has finished processing the pixel data (e.g., the output data 1104), the pixel data may be written to a render target such as a frame buffer, a color buffer, or the like.

It will be appreciated that one or more additional stages may be included in the graphics processing pipeline 1100 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading 1112 stage). Other types of graphics processing pipelines are contemplated as being within the scope of the present disclosure. Furthermore, any of the stages of the graphics processing pipeline 1100 may be implemented by one or more dedicated hardware units within a graphics processor such as parallel processing unit 520. Other stages of the graphics processing pipeline 1100 may be implemented by programmable hardware units such as the streaming multiprocessor 800 of the parallel processing unit 520.

The graphics processing pipeline 1100 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the parallel processing unit 520. The API provides an abstraction for a programmer that lets a programmer utilize specialized graphics hardware, such as the parallel processing unit 520, to generate the graphical data without requiring the programmer to utilize the specific instruction set for the parallel processing unit 520. The application may include an API call that is routed to the device driver for the parallel processing unit 520. The device driver interprets the API call and performs various operations to respond to the API call. In some instances, the device driver may perform operations by executing instructions on the CPU. In other instances, the device driver may perform operations, at least in part, by launching operations on the parallel processing unit 520 utilizing an input/output interface between the CPU and the parallel processing unit 520. In an embodiment, the device driver is configured to implement the graphics processing pipeline 1100 utilizing the hardware of the parallel processing unit 520.

Various programs may be executed within the parallel processing unit 520 in order to implement the various stages of the graphics processing pipeline 1100. For example, the device driver may launch a kernel on the parallel processing unit 520 to perform the vertex shading 1108 stage on one streaming multiprocessor 800 (or multiple streaming multiprocessor 800 modules). The device driver (or the initial kernel executed by the parallel processing unit 520) may also launch other kernels on the parallel processing unit 520 to perform other stages of the graphics processing pipeline 1100, such as the geometry shading 1112 stage and the fragment shading 1118 stage. In addition, some of the stages of the graphics processing pipeline 1100 may be implemented on fixed unit hardware such as a rasterizer or a data assembler implemented within the parallel processing unit 520. It will be appreciated that results from one kernel may be processed by one or more intervening fixed function hardware units before being processed by a subsequent kernel on a streaming multiprocessor 800.

LISTING OF DRAWING ELEMENTS

| | |
|---|---|
| 102 | transmitter |
| 104 | receiver |
| 202 | serializer |
| 204 | latch |
| 206 | phase-locked loop |
| 208 | configurable delay circuit |
| 210 | clock divider |
| 212 | de-serializer |
| 302 | message |
| 400 | LINK_RDY |
| 402 | LINK_RDY |
| 404 | SETTING |
| 406 | sends data patterns on Y data lanes (at high data rate) |
| 408 | evaluates the efficacy of the setting |
| 410 | END |
| 412 | RESULT |
| 414 | END |
| 416 | RESULT |
| 502 | I/O unit |
| 504 | front-end unit |
| 506 | hub |
| 508 | scheduler unit |
| 510 | work distribution unit |
| 512 | memory |
| 514 | crossbar |
| 516 | NVLink |
| 518 | interconnect |
| 520 | parallel processing unit |
| 600 | general processing cluster |
| 602 | pipeline manager |
| 604 | pre-raster operations unit |
| 606 | data processing cluster |
| 608 | raster engine |
| 610 | M-pipe controller |
| 612 | primitive engine |
| 614 | work distribution crossbar |
| 616 | memory management unit |
| 700 | memory partition unit |
| 702 | raster operations unit |
| 704 | level two cache |
| 706 | memory interface |
| 800 | streaming multiprocessor |
| 802 | instruction cache |
| 804 | scheduler unit |
| 806 | dispatch |
| 808 | register file |
| 810 | core |
| 812 | special function unit |
| 814 | load/store unit |
| 816 | interconnect network |
| 818 | shared memory/L1 cache |
| 900 | processing system |
| 902 | parallel processing module |
| 904 | switch |
| 906 | central processing unit |
| 1000 | exemplary processing system |
| 1002 | main memory |
| 1004 | network interface |
| 1006 | display devices |
| 1008 | input devices |
| 1010 | communications bus |
| 1100 | graphics processing pipeline |
| 1102 | input data |
| 1104 | output data |
| 1106 | data assembly |
| 1108 | vertex shading |
| 1110 | primitive assembly |
| 1112 | geometry shading |
| 1114 | viewport SCC |
| 1116 | rasterization |
| 1118 | fragment shading |
| 1120 | raster operations |

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A system comprising:
a first circuit;
a second circuit;
a link between the first circuit and the second circuit, the link comprising a plurality of data lanes; and
the first circuit and the second circuit configured to determine a delay setting of a clock signal forwarded from the first circuit to the second circuit by:
utilizing a first distinct subset of the data lanes to communicate commands redundantly encoded in multiple unit intervals of the data lanes; and
utilizing a second distinct subset of the data lanes to communicate results of the commands.

2. The system of claim 1, wherein the results are redundantly encoded in multiple unit intervals of the clock signal.

3. The system of claim 1, wherein the commands are redundantly encoded in three or more unit intervals of the clock signal.

4. The system of claim 1, wherein the commands comprise indications of changes in settings for the delay.

5. The system of claim 4, wherein the indications of changes in settings for the delay are communicated from the first circuit to the second circuit.

6. The system of claim 1, wherein the results comprise an indication of a setting for the delay that provides a most effective timing of an edge of the clock signal for sampling the unit intervals at the second circuit.

7. The system of claim 6, wherein the indication of the setting for the delay is communicated from the second circuit to the first circuit.

8. The system of claim 1, wherein the results comprise an indication of an efficacy of a setting for the delay on a timing of an edge of the clock signal for sampling the unit intervals at the second circuit.

9. The system of claim 8, wherein the indication the efficacy of the setting for the delay is communicated from the second circuit to the first circuit.

10. A transceiver comprising:
a transmitter;
a receiver;
a link coupling the transmitter and the receiver, the link comprising N data lanes operable at a top bandwidth rate determined by a transmitter clock signal; and
the transceiver configured to set a delay of the transmitter clock signal on the link by:
utilizing a first number X of the data lanes to communicate commands redundantly encoded in multiple unit intervals of the transmitter clock signal at the top bandwidth rate; and
utilizing all N of the data lanes to communicate test data for the commands at the top bandwidth rate.

11. The transceiver of claim 10, wherein the commands are redundantly encoded in three or more unit intervals of the transmitter clock signal.

12. The transceiver of claim 10, utilizing a second number Y<=N−X of the data lanes to communicate results of the commands redundantly encoded in multiple unit intervals of the transmitter clock signal at the top bandwidth rate.

13. The transceiver of claim 12, wherein the results are redundantly encoded in three or more unit intervals of the transmitter clock signal.

14. The transceiver of claim 10, wherein the commands are one-hot encoded.

15. The transceiver of claim 10, wherein the commands are binary encoded.

16. The transceiver of claim 10, wherein the commands comprise indications of changes in settings for the delay.

17. The system of claim 10, wherein the commands comprise an indication of a setting for the delay that provides a most effective timing of an edge of the transmitter clock signal for sampling the data at the second circuit.

18. The system of claim 10, wherein the results comprise an indication of an efficacy of a setting for the delay on a timing of an edge of the transmitter clock signal for sampling the data.

19. A process for configuring a communication link between a first chip and a second chip, the process comprising:
utilizing a first distinct set of data lanes of the link to communicate commands between the chips redundantly encoded in multiple unit intervals of the data lanes at a full bandwidth of the link;
utilizing a second distinct set of the data lanes to communicate results of the commands between the chips in multiple unit intervals of the data lanes at a full bandwidth of the link; and
wherein the commands traverse a range of delay settings for a clock signal forwarded over the link.

20. The system of claim 19, further comprising utilizing all of the data lanes to communicate test data for the commands at the full bandwidth.
